(19) United States
(12) Patent Application Publication
(10) Pub. No.: US 2011/0108620 A1
(43) Pub. Date: May 12, 2011

(54) SYSTEM AND METHOD FOR RECYCLING OF ARTICLES

(75) Inventors: Michael WADDEN, Paradise (CA); Jonathon DROVER, St. John's (CA); Kurt W. WILLIAMS, St. John's (CA)

(73) Assignee: EVER GREEN ENVIRONMENTAL CORPORATION, ST. JOHN'S (CA)

(21) Appl. No.: 12/898,175

(22) Filed: Oct. 5, 2010

Related U.S. Application Data
(60) Provisional application No. 61/248,669, filed on Oct. 5, 2009.

(51) Int. Cl. G06Q 40/00

(52) U.S. Cl. 235/379

(57) ABSTRACT

A system for receiving recyclable items having a deposit value from a customer, comprising a user station comprising means to generate tags bearing a unique tag identifier, an operator station comprising an operator interface for entering the tag identifier and the numbers and types of recyclable items, and a computer in communication with the customer and operator interfaces, to calculate the total deposit value for recyclable items and ascribe a deposit value to said customer account, and to update the customer account with a monetary amount correlating to said deposit value, is herein disclosed.

### CROSS-REFERENCE TO RELATED APPLICATION

This application claims the benefit of U.S. application No. 61/248,669, filed on Oct. 5, 2009, the contents of which are incorporated herein by reference.

### FIELD OF THE INVENTION

The invention relates to systems and methods for handling of recyclable articles that bear a deposit value, such as recyclable bottles and cans. In particular, the invention relates to an integrated system for tracking recyclable articles received from a customer and generating a customer account wherein the deposit values of recyclable articles are ascribed to the customer.

### BACKGROUND

Within many jurisdictions, consumers are encouraged to recycle a variety of articles such as beverage bottles and the like, by a deposit system wherein a deposit is charged at the point of purchase, which can be redeemed when the article is returned to a deposit location. Unfortunately, compliance with this type of system remains far from perfect; this may be due in part to the inconvenience suffered by the consumer when returning the articles. For many individuals, the inconvenience outweighs the value of the returned deposit. While increasing the amount of the deposit may increase compliance, this is often undesirable to due to the hardships it imposes on the less wealthy. A preferable approach is to increase compliance by reducing the inconvenience factor; this is expected to result in more such articles being returned by consumers. This will achieve an overall economic benefit as it places more disposable income in the hands of consumers, and as well achieves significant environmental benefits in terms of recycling of items and reduced burden on landfills.

A significant inconvenience factor relates to the time required by consumers waiting at deposit centers while their articles are counted, sorted, etc. This can give rise to lineups during busy hours, and can result in overall frustration with the amount of time required for the relatively small deposit amount generally received by a customer. This has resulted in an increasing portion of recyclable containers being diverted to landfill, in particular as the value of deposits, which tend not to be increased over time, is slowly eroded by inflation. There is thus a need to provide a system for speeding up and generally facilitating the process of returning recyclable items and processing the deposit amounts.

One constraint on handling of returned articles resides in the physical limitations imposed at a typical recycling center. Typically, numerous consumers arrive at peak hours, and the recycling centers often have only a small area devoted to the consumer intake area or a small staff to process the returns, resulting in bottlenecks when processing the recyclable items. As well, certain users of the system, particularly those engaged in gathering recyclable items on a large scale, can bring in very large numbers of such items, thereby aggravating the bottlenecks. In order to address such problems, various automated systems have been proposed and developed, for example vending-type machines which accept recyclable items and return the deposit amount to the consumer. However, such machines are highly complicated and costly, and are generally only capable of recognizing a relatively small range of recyclable items, such as conventional beer bottles or soda cans. As a result, it can be difficult for such machines to adapt to the introduction of a deposit on a new type of article. As well, the high cost of such machines generally limits the numbers of machines and locations where these are available, resulting in the same bottleneck problem as noted above. It is thus desirable to provide a system which is relatively inexpensive and avoids at least some of the above drawbacks.

An improved system for processing of recyclable articles was disclosed in a previous application filed by the present applicant, namely U.S. application Ser. No. 12/080,632, filed on Apr. 4, 2008. The present invention relates to improvements of said system.

### SUMMARY OF THE INVENTION

According to one aspect, the invention relates to a system for receiving unsorted recyclable articles having a deposit value from a customer, said customer having a customer information carrier bearing a unique customer identifier, or other means to confidentially access a controlled system. The articles are placed within a container such as a bag or box, to which a unique container identifier can be attached. The container can be filled with articles either when operating the customer interface described below, or in advance. The system comprises:

a customer interface, which may be associated with an unmanned user station, configured to exchange data with a remote data center. The interface may be incorporated in a user-friendly and robust station such as a free-standing kiosk. The interface includes a reader to read the customer information carrier, a data input to receive information from the customer as to the number of containers being deposited by the customer, and a printer or other tag generator to generate tags bearing a unique tag identifier to individually attach to the container(s) that are being deposited at the user station;

an operator interface, which may be remote from the customer interface, for entering the tag identifier and the numbers and types of recyclable items within the container associated with said tag;

a computer in operative communication with said customer interface and said operator interface, comprising program instructions to generate a customer account for said customer including selected customer data, to store and update data relating to individual customer accounts, to record the number of tags issued to said customer at said customer interface and the unique tag identifier information associated therewith, to calculate the total deposit value for recyclable items entered at said operator interface and ascribe said deposit value to said customer account, and to update said customer account with a monetary amount correlating to said deposit value; and

a data link between said customer and operator interfaces and said computer.

The customer identifier may comprise any technically feasible means to store customer account access information on a card or other information carrier, such as an optically-scannable bar code, magnetic strip, pre-programmed chip, or the like. It is contemplated that advances in technology will result in a wide variety of means to store information in small, portable structure that can be easily carried by a customer. The customer interface includes a means to automatically read the identifier, such as a bar code scanner, magnetic strip reader or the like. A reasonable alternative is for all customer information to be stored by a central computer, which may be accessed by a means such as entry of a PIN number, or by reading of another secure information carrier such as a credit card, such that the customer is not required to carry a physical information carrier.

The tag which is issued to the customer bears any convenient and technically feasible means to store information in a fashion that can be automatically read at the operator interface, such as scannable bar code, magnetic strip or the like.

In another aspect, the user interface permits the customer to enter the number of recyclable containers being deposited by said customer in a given transaction, said user interface generating corresponding unique identifier tags for each container, and wherein said user interface communicates the total number of said tags issued in the transaction to the central computer. The customer-generated information can be confirmed by an operator at a subsequent stage, and the customer account information being updated if necessary.

The computer may be adapted to update said customer account with information specific to each customer transaction, with the information such as the date and time of issuing of a tag to said customer, the number of tags issued to said customer, the number and types of recyclable articles within each said container, the deposit value associated with each of said articles, and similar information for any selected time period.

According to another general aspect, the invention relates to a method for processing recyclable articles, using the system described above to carry out the following steps:

establishing a customer account containing customer information

providing a customer with an information carrier bearing a unique customer identifier permitting access to said customer account, such as a card with a chip, bar code or magnetic strip; alternatively, system access may be provided by entry of secure information by the customer;

permitting a customer transaction at an unmanned deposit station, consisting of reading the customer information carrier with a reader to obtain customer identification information, and communicating said information to an information processor;

receiving input from the customer as to the number of containers of recyclable articles that the customer intends to deposit at the station;
generating one or more tags corresponding to the number of such containers, wherein the tags each bear a unique container identifier, said unique identifier container information being stored within said processor linked to the corresponding customer account;
attaching said tag to a container which contains the customer's recyclable articles,

at a remote operator station, entering into said processor for each of said containers: a) the numbers and types of recyclable articles within said container and b) the unique container identifier associated with said container; and

calculating a deposit value for said containers and updating said customer account to add said deposit value thereto.

The invention further relates to an unmanned recycling station, consisting of a consumer interface as described above, operatively linked to a central computer for providing the functions as described above, and a location for depositing bags or other containers that have been labeled with a unique tag associated with a customer account and which contain recyclable articles, for subsequent sorting and processing of deposit information into a customer account.

The invention will be further described by a non-limiting detailed description of an embodiment.

### BRIEF DESCRIPTION OF THE DRAWINGS

At least one embodiment of the invention is set forth in the following description and is shown in the drawings and is particularly and distinctly pointed out and set forth in the appended claims.

FIG. 1 is a schematic drawing showing the present system;

FIG. 2 illustrates the present system and method; and,

FIG. 3 is a schematic drawing of an unmanned recycling station according to the present invention.

### DETAILED DESCRIPTION

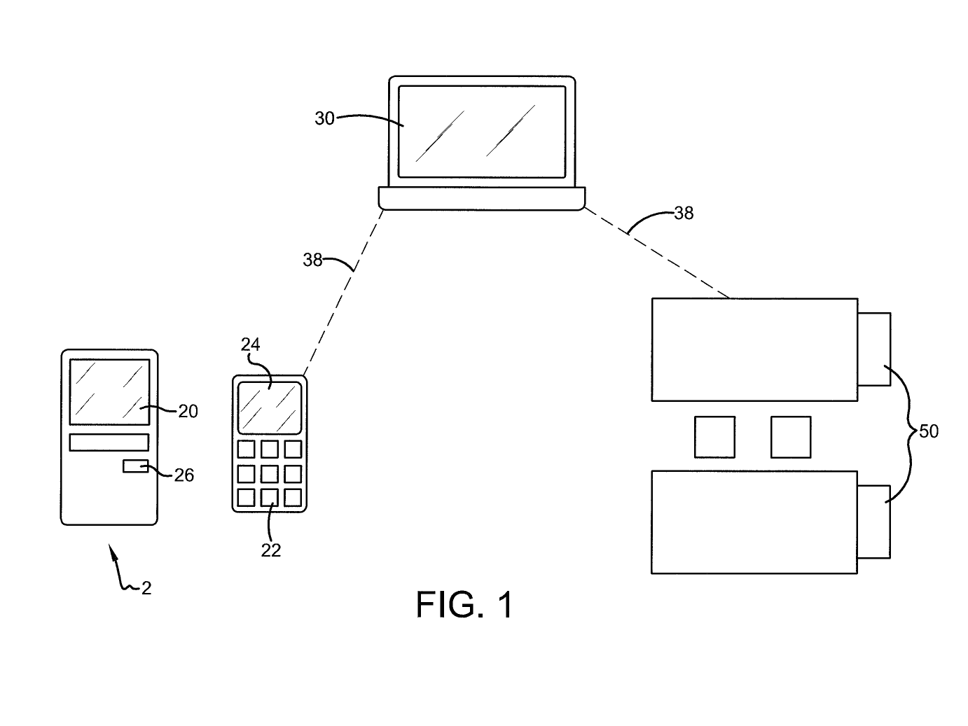

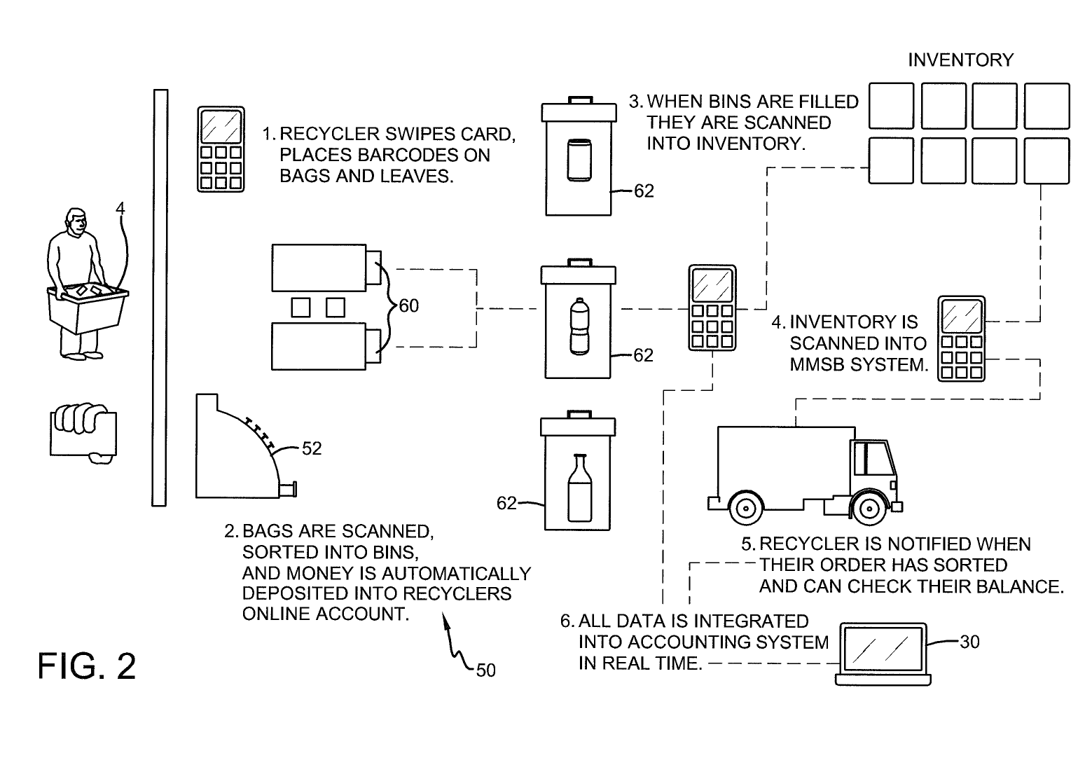

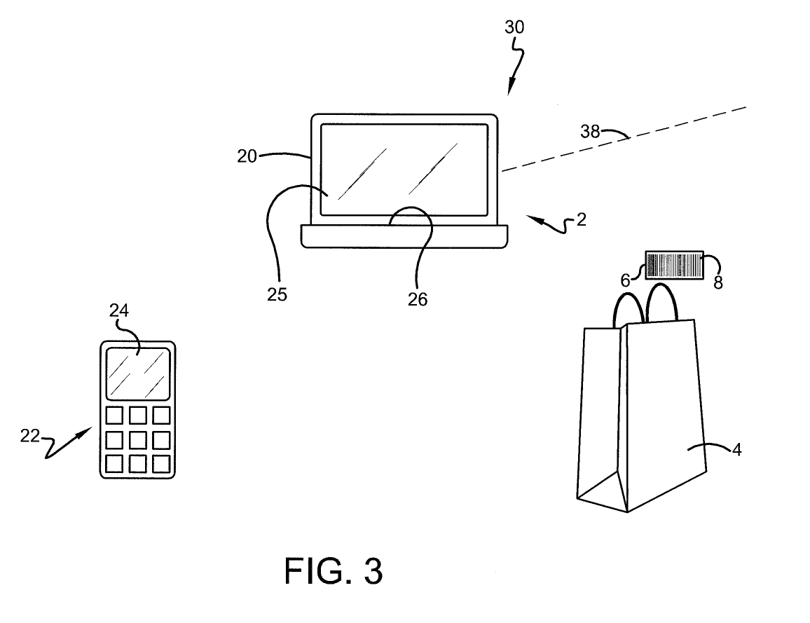

Turning to FIGS. 1-3, the present system includes an unmanned user station 2, which can be located at any convenient location, such as a shopping mall. The user station is intended for use by a customer who wishes to deposit a number of recyclable articles such as deposit bottles, and other items or containers for which a deposit has been paid. The customer may also wish to deposit other types of recyclable articles which do not bear a deposit, and the present system is suitable for this purpose as well. Typically, the customer will have pre-packaged the items within a bag 4 or other container. The customers may have been previously supplied with standardized bags or containers, although this is not essential and customers may supply their own bags. Suitable bags or other containers may also be available at the user station for customers to fill on the spot with their articles. Bags 4 should be well sealed to prevent recyclable articles from falling out during handling. For this purpose, customers may be supplied with fasteners 6 which securely seal the bags. Conveniently, the fastener may also include a unique identifier tag 8, as will be described below.

Customers at the station encounter a user interface unit 20, which may comprise a kiosk or similar interactive display unit. The interface may comprise a free-standing unit, or a unit which is placed on a table, counter or other support. The interface unit is suitably robust to withstand the normal requirements of an unmanned station. Customers use a pre-issued card 22 or similar information carrier to initiate use of the system. The information carrier includes a unique customer identifier 24 such as a magnetic strip, chip, barcode, RFID or other machine-readable data carrier. Customer identifier 24 can be read by card reader 26 incorporated with interface unit 20 to permit access to a pre-established customer account. In most cases, customers entering the facility will have already registered with the system, and will have been previously issued a customer identification card and an associated account. However, for a new customer, the customer will be required create an account. This may require the customer to input basic identification into the customer interface, for example full name, address, contact information and any other suitable information as may be required. This information is recorded in the central computer 30, as described below. The customer can be mailed the card at a later date, for future use. The user station may also be equipped to generate and dispense the card on the spot.

The user interface unit 20 includes a screen 25 or other similar display. Preferably, the screen is a touch screen or alternatively a separate screen and keyboard (not shown) is provided to permit customers to view and input information. Upon insertion or scanning of customer card 22, the user interface sequentially displays the following information, in a fashion wherein each sequential screen is displayed upon command by the user:

display of customer identification for optional verification by the customer;

the customer can be asked to he wishes to be shown his current account information, which may comprise any aspect of the account, such as the current account balance, number of items deposited for recycling within a previous specified period, or other information;

request the customer to input the number of bags or containers containing recyclable items that the customer wishes to deposit at the present visit;

optionally, the customer can be asked to verify the selected number of bags.

The user interface unit 20 will then generate the appropriate number of container or bag tags. These may consist of stick-on labels or any other convenient information carrier which may be fastened or attached to the customer's containers. It is desirable to provide a tag which is suitable for attachment to a wide range of container types and materials. Suitably, a stick-on paper or plastic label is appropriate for most uses. Alternatively, if customers are limited to the use of bags or sacks for returning items, in particular standardized bags supplied to the customers, then a secure bag closure may be provided which incorporates the tag. This arrangement is desirable in that it ensures that the customer can be provided with a secure bag closure to minimize the risk of inadvertent premature or unauthorized opening of the bag. The identifier tag bears a unique identifier, such as a uniquely generated barcode.

The identifier tags are printed using a bar-code printer within the kiosk.

The customer can then apply tags 8 to the bags he has brought to the recycling station. The labeled bags are deposited at the station.

User interface 20 includes an information processor, such as a pre-programmed chip or a general purpose computer, programmed to carry out the functions described above. User interface 20 is in operative communication with central computer 30 via a data link 38. Computer 30 may be associated with multiple recycling stations via multiple data links. Data link 38 comprises any suitable digital communication means capable of transmitting digital information from the kiosk to the central computer, such as a wireless communication link. The functions of central computer 30 will be described more fully below.

The user station further comprises a secure location to receive the containers 4, in order to avoid theft of the containers left by the customer. The secure location can comprise, for example, a cabinet or other large container having a lockable door and a one-way hatch, which can be integrated with the user station or located adjacent thereto.

The system further comprises an operator station 50 for carrying out the functions of counting and sorting the recyclable articles and entering the corresponding deposit information in the associated customer accounts. Operator station 50 is located at a position which is removed from the user station. The station 50 may be located remotely or at the same general location as user station 2. A remote location for operator station 50 is particularly suitable where space for user station 2 is at a premium, for example at a shopping mall. It can also be desirable to provide a number of relatively small scale user stations with a more limited number of centralized operator stations located remotely from at least some of the user stations.

Operator station 50 comprises a facility for opening the customer bags or other containers 4 and counting and sorting the individual recyclable containers. The sorting may comprise sorting according to various criteria, which may include container type such as beer bottles, wine bottles, etc., glass colour or any other selected criteria. The sorting process is generally conventional and may be carried out by hand or by machine. Operator station 50 includes an operator interface 52, configured for convenient use by the sorters, to permit the operator to enter information into computer 30 relevant to the sorted articles being processed by the operator. Alternatively, if the sorting occurs by machine, the interface is incorporated is incorporated within the sorting machine so as to automatically input the required information.

Operator interface 52 comprises any convenient means to input data into computer 30 and to receive data from computer 30 as required to permit the operator to update the customer account with the information derived from sorting the customer's bags. Without limitation, the data input means may comprise a touchscreen, a handheld device, a keyboard and screen combination, a voice-activated system, or various combinations of the foregoing.

Operator station 50 comprises any suitable and convenient arrangement and configuration of tables 60, bins 62 and other equipment to permit the rapid and safe sorting of the containers, commencing with the opening of the customer bags and proceeding with the removal of the recyclable containers, entering the container types via interface 52 and depositing the sorted containers into receptacles. Bins 62 are bar code labeled to permit the operator to scan the bin information into the central computer 30.

Prior to sorting the articles within a bag 4, the operator will input the associated tag 8 into the interface, for example by scanning the barcode printed on the tag. In this fashion, individual container and customer information is entered into the information processor. As the recyclable articles are sorted, the operator also enters data into the customer account. For example, the operator interface may graphically display the article types and/or the deposit amounts, if any, and the operator can then enter the data corresponding to these articles into the customer account individually as articles are removed from the container, or after counting the operator may enter total number of each type of article. If the customer has inputted the number of recyclable articles when he deposited the bag at the user station, this information can be compared with the corresponding data generated at the operator station and the customer account updated if required.

The sorted articles are then placed within bins or other receptacles, for subsequent removal. The recyclable articles may comprise essentially any number and types of articles, not all of which may bear a deposit. In the case of articles that do not bear a deposit, the sorter may proceed to sort such articles in a fashion similar to the sorting of deposit articles. The operator may then enter the number and types of non-deposit articles received, or alternatively this information need not be entered since it will not affect the customer's account information. In this fashion, the system may be used in communities that do not provide a curbside recycling program, so as to permit consumers to recycle their recyclable articles at the same time as returning deposit-bearing articles. Optionally, information relating to both the deposit and non-deposit bearing articles may be input into the customer account, which permits the system to calculate the “carbon footprint” and other environment information relating to the customer's deposit. Such information includes the number and types of containers deposited by the customer. The computer 30 can be programmed with information relevant to the environmental factors respecting a number of types of recyclable articles, which can then be used to ascribe selected environmental information to the customer account.

Upon completion of the sorting operation, including the associated data entry, an automatic notification is sent to the user to indicate that the containers have all been sorted, and that the customer's account balance has been updated and is ready for viewing.

When bins 62 are filled at the sorting station, the operator scans the bin information at the user station interface, thereby inputting the bin information into the computer 30. Each bin is coded to indicate the type of container or article intended to be kept within the bin. The computer tracks the inventory of filled bins at the operator station. When the inventory reaches a predetermined level, an order for a bin pickup is triggered.

The operator station 50 may comprise a single sorting location and single operator interface 52. More typically, the sorting station will accommodate a number of sorters, each with an operator interface in communication with computer 30.

Computer 30 may comprise a general purpose high speed computer, comprising program information to configure the computer to carry out the functions required to operate the present system. Preferably, the computer is also connected to the internet via secure internet connection for access to customer accounts by customers, operators and others.

Computer 30 is programmed to carry out the following operations and functions:

Maintain a database of customer accounts, including for each customer, the personal information for said customer, including a customer number assigned to the customer and optionally banking or other financial information for the customer such as a credit card or Paypal™ account to permit funds to be transferred, as well as an account for said customer including the deposit funds attributed to said customer, and a record of transactions of said customer with the system.

Generation of new customer accounts, including assignment of a customer number, or optionally the customer number may be supplied to the system from an external source such as a number being selected by the customer. Optionally, each customer may be identified by a customer number and/or user name as well as a confidential password. The customer account is initially randomly generated by the system until the user activates his account and configures his account details.

Receiving customer information from the customer interface, including accessing the customer account when triggered to do so by the reading of the customer identifier at the interface, and receiving from said interface the number of bag identifier tags required the customer, and any other information entered by the consumer in response to prompts generated by the system.

Signaling to said user interface to generate a corresponding number of tags, each of said tags comprising a unique identification number or other encoded information, and maintaining a record for said customer of said tags including the tag identifier information, and optionally generating a statement for said customer indicating information such as the date and time of said transaction, the number of tags issued to the customer and optionally other account information relevant to the customer.

Receiving from the operator interface information corresponding to an individual tag identifier, and opening and accessing the customer account corresponding to said identifier. Upon opening of a customer account at the operator end by scanning or otherwise reading the bag tag into the operator interface, the operator is provided only limited information respecting the customer account. For privacy considerations, this information may be limited to simple confirmation that the tag identifier entered by the user corresponds to a valid customer account.

In response to information entered by the operator respecting the numbers and types of recyclable articles contained within a customer bag, entering into said customer account the numbers and types of deposit-bearing containers entered by the operator, and updating the customer account in respect of the value of said deposits.

Permitting customers to access their accounts, either via a secure digital connection or at a customer interface, and displaying selected customer account information, including the deposit value belonging to said customer held within said account.

Generating system-wide deposit information for each container type, and conveying said tabulated information to a recipient, such as a beverage container source or other entity responsible for paying out deposits, and receiving an electronically transmitted funds transfer from said entity, corresponding to the calculated deposit amount. This step may comprise generating and conveying said information on a real-time basis in which the information is generated on a constant basis, or alternatively the system-wide information may be updated on a periodic basis, for example hourly or daily.

Ascribing at least a portion of said deposit amounts into individual customer accounts, corresponding to the deposit values for the containers returned by said customer. Optionally a portion of the deposit amounts paid to the system can be retained by the system operator, as compensation for providing and operating the system. Optionally, the customer can be automatically sent an email or other communication indicating the updated account information to reflect the newly deposited articles, including the numbers and types of articles ascribed to the customer and the deposit value added to the customer account.

Upon request by a customer, transferring the deposit amounts to a third party, such as a bank account, credit card, PayPal™ account, or other means to transfer the funds from the system account to an account of an individual customer. Optionally, the funds may be supplied to a customer in the form a cheque issued by the system and delivered to the customer.

All communication with the customer is engaged by the use of a bar coded card so as reduce the possibility of errors in identity. In the instance that a card is misplaced or not functioning, all customer information is available through a secure administration portal. This portal can be used to generate a new card or remedy human errors that may occur.

Optionally, the system may accumulate information and data on a periodic, real time or on-demand basis relating to system-wide basis relating to the total amounts of materials processed. Such information and data may include the total numbers of articles that have been processed by the system, organized by criteria such as types of articles, geographic locations of the customers, and the like. Such information and data may be used to generate periodic reports. One use of such reports is for submission to a greenhouse gas credit organization to obtain greenhouse gas credits or other benefits from the recycling activities.

Optionally, the computer may be programmed to provide an “environmental calculator” for each customer, accessible via the individual customer account. The environmental calculator provides information relating to the environmental benefits of the customer's activities and optionally other customers as well, including such aspects as the amounts of carbon and other resources saved by the customer's recycling activities.

In addition, advertising messages may be displayed at various opportunities, such as at the customer interface, either before or after the customer information is input, or on the user-accessible website, either before or after the customer account is accessed.

A further option for the customer account is to provide the customer with the option to donate all or a portion of the funds held in the customer account to a charitable organization. For this purpose, the system conveys the funds, along with the customer information, to the requested charity. The charity may then issue a receipt directly to the customer, or the receipt may be generated by the system and forwarded to the customer.

The present invention has been described in the foregoing by reference to a detailed description of particular embodiments and aspects of the invention. The present invention is not limited to said embodiments and aspects, but embodies departures from and equivalents thereof. The present invention is defined by the present patent specification as a whole, including the claims, as well as embodiments which are within the spirit and scope of said claims and specification, and functional equivalents thereof as would be understood by persons skilled in the art to which this invention pertains.

The invention has been described with reference to several embodiments. Obviously, modifications and alterations will occur to others upon a reading and understanding of the specification. It is intended by applicant to include all such modifications and alterations insofar as they come within the scope of the appended claims or the equivalents thereof.

Having thus described the invention, it is now claimed:

1. A system for receiving recyclable articles having a deposit value from a customer, said articles being held in bulk within a container, said system comprising:
a customer station comprising a reader to read a machine-readable customer information carrier associated with said customer, a customer-operable information input, and a tag generator for generating and dispensing a tag bearing a unique tag identifier for attachment to said container;
an operator station removed from said customer station comprising an operator interface for reading or entering information from the tag identifier and for entering the numbers and types of recyclable articles within the container associated with said tag; and,
a computer in operative communication with said customer station and said operator station, said computer comprising program instructions to: generate an individual customer account for said customer, to store and update data relating to said customer account, to record the number of tags issued to said customer at said customer interface and the unique tag identifier information associated therewith, to calculate the total deposit value for recyclable articles entered at said operator interface associated with said tag, ascribe said deposit value to said customer account, and to update said customer account with a monetary amount correlating to said deposit value.

2. The system of claim 1 wherein the customer identifier comprises a data carrier selected from one or more of the group comprising an optically-scannable bar code, a magnetic strip, an RFID device, and a readable computer chip.

3. The system of claim 1 wherein said user station is unmanned and remote from said operator station.

4. The system of claim 1 wherein said computer is adapted to communicate said customer account information via a global computer network connection.

5. The system of claim 1 wherein said computer is remote from said user and operator station.

6. The system of claim 1 wherein said user interface permits said customer to enter the number of containers being deposited at the station by said customer, each of said containers being associated with one of said tags, and wherein said user interface communicates the total number of said tags issued to said customer to said central computer.

7. The system of claim 1 wherein said computer is adapted to transfer a selected amount of the funds in said customer account to said customer or other selected recipient.

8. The system of claim 1 wherein said computer is adapted to update said customer account with information specific to each customer transaction selected from the group comprising date and time of issuing of a tag to said customer, the number of tags issued to said customer, the number and types of recyclable articles within each said container, the deposit value associated with each of said articles, and similar information for any selected time period.

9. The system of claim 1 wherein said operator station comprises a data entry means selected from the group comprising a touchscreen, a handheld device, a combination of screen and keyboard, a voice-activated system, and combinations thereof.

10. A method for processing recyclable articles having a deposit value, wherein said articles are within a sealed container, comprising the steps of:
establishing a customer account containing customer information;
providing a customer with an information carrier bearing a unique customer identifier which permits access to said customer account;
at a customer station, reading said customer identifier with a reader to obtain customer identification information, and communicating said information to an information processor;
generating at least one tag comprising a unique container identifier;
communicating said identifier to said information processor;
attaching said tag to said container;
at an operator station, reading the tag with a tag reader in communication with said information processor;
responsive to reading of said tag, accessing and opening at least a portion of said customer account at said operator station;
determining for said container the numbers and types of recyclable containers within said container and communicating said information to the information processor;
calculating a deposit value of said articles within the container;
updating said customer account to update the monetary value within said account responsive to said calculated deposit value; and,
providing a payment to said customer of all or part of the monetary value in said account.

11. The method of claim 10 wherein said customer identifier includes a data carrier selected from one or more of the group comprising an optically-scannable bar code, a magnetic strip, an RFID device, and readable computer chip.

12. The method of claim 10 wherein said information processor comprises a general purpose computer comprising program instructions.

13. The method of claim 12 wherein said computer is adapted to communicate said customer account information via a global computer network connection.

14. The method of claim 12 wherein said computer is remote from said user and operator interfaces.

15. The method of claim 10 wherein said user interface permits said customer to enter a number reflective of the number of containers supplied by said customer, said user interface generating a separate identifier tag for each said container, and wherein said user interface communicates the total number of said tags issued to said customer to said central computer.

16. The method of claim 10 wherein said computer is adapted to transfer any portion of the monetary value in said customer account to a selected recipient.

17. The method of claim 10 wherein said computer is adapted to update said customer account with information specific to each customer transaction selected from the group comprising the date and time of issuing of a tag to said customer, the number of tags issued to said customer, the number and types of recyclable articles within each said container, the deposit value associated with each of said articles, for any selected time period.
